(19) United States
(12) Patent Application Publication
(10) Pub. No.: US 2010/0204419 A1
(43) Pub. Date: Aug. 12, 2010

(54) POLYMERISATION METHOD

(76) Inventors: Rebecca Lesic, New South Wales (AU); Thomas Maschmeyer, New South Wales (AU); Anthony Frederick Masters, New South Wales (AU); Antony John Ward, New South Wales (AU)

Correspondence Address: BRINKS HOFER GILSON & LIONE, P.O. BOX 10395, CHICAGO, IL, 60610, US

(21) Appl. No.: 12/667,144

(22) PCT Filed: Jun. 27, 2008
(86) PCT No.: PCT/AU08/00941

§ 371 Date: Apr. 26, 2010

(30) Foreign Application Priority Data
Jun. 29, 2007 (AU) 2007903543

(51) Int. Cl. C08F 2/04; C08F 4/18; C08F 4/12; C08F 118/04

(52) U.S. Cl. 526/107; 526/130; 526/154; 526/319; 526/335

(57) ABSTRACT

Disclosed herein is a method of forming a polymer, wherein the polymer is formed by a radical polymerisation reaction initiated by a solid oxide compound.

### FIELD OF THE INVENTION

The invention relates to a method of forming a polymer.

### BACKGROUND ART

Polymerisation is an essential part of many industrial processes, such as the production of plastics, paints and coatings as well as various electronic and biomedical devices. Polymers can be produced using several different synthetic pathways, such as Atom Transfer Radical Polymerisation (ATRP) and free radical polymerisation.

ATRP is one of the most common types of radical polymerisation and can be used to prepare homopolymers, and random, gradient, block, graft and dendritic polymers with well defined structures. In order to initiate an ATRP reaction, it is necessary to generate a radical, typically via a reversible redox process catalysed by a transition metal complex. The transition metal complex is typically grafted to a heterogeneous support material such as silica. In these processes, the transition metal complex undergoes a one electron oxidation and simultaneous extraction of a halogen atom from a halogenated initiator, usually an organic halide. The removal of the halogen generates an active species that can undergo addition to a monomer, thus initiating polymerisation.

ATRP processes require a sophisticated and often expensive catalyst and require both the catalyst and a halogenated initiator. Due to the nature of many of these catalysts, the reactions must be conducted in the absence of oxygen to prevent catalyst poisoning. These catalysts are also often expensive and, although heterogeneous in nature, are susceptible to leaching, which prevents them from being recycled and raises serious environmental issues.

Free radical polymerisation is also used to form polymers. In this process, radicals are generated as a result of the decomposition of an unstable initiator, such as an azo compound or a peroxide-based compound. As the initiator breaks down it produces “free” radicals that attack the given monomer, thereby initiating polymerisation. Throughout the reaction, “free” radicals are transferred from the initiator and along the growing polymer chain as new monomers are incorporated. The initiators used in prior art free radical polymerisation processes are highly reactive and extremely unstable and require that great care be taken in storing them.

It would be advantageous to provide an alternative method of forming a polymer.

### SUMMARY OF THE INVENTION

The inventors have surprisingly found that a radical polymerisation reaction can be initiated by a solid oxide compound in the absence of additional catalysts and initiators.

The present invention therefore relates generally to a method of forming a polymer, wherein the polymer is formed by a radical polymerisation reaction initiated by a solid oxide compound.

Typically, the method comprises the steps of:
(a) providing a reaction mixture that comprises:
   one or more monomers; and
   a solid oxide compound; and
(b) polymerising the one or more monomers by a radical polymerisation reaction initiated by the oxide compound.

Typically, the one or monomers are dissolved in a solvent. As those skilled in the art will appreciate, most oxide compounds which are solid at ambient conditions (that is, at room temperature and in air at atmospheric pressure) are relatively non-toxic and relatively easy to handle. Accordingly, the present invention provides a method of forming a polymer that can be carried out without the use of toxic or dangerous catalysts or unstable halogenated initiators. As such, the method of the present invention can provide an alternate method for performing radical polymerisation that is cheaper, less dangerous and more environmentally friendly than many existing processes.

Step (b) may comprise exposing the reaction mixture to conditions (e.g. a temperature and pressure) whereby a radical polymerisation reaction is initiated by the oxide compound.

The reaction mixture typically consists essentially of one or more monomers dissolved in a solvent and one or more solid oxide compounds. That is, the reaction mixture typically contains no additional catalysts or other initiators, such as organic halides.

The oxide compound may, for example, be silica, titania or alumina.

In some embodiments, the oxide compound is a composite of two or more of silica, titania or alumina, for example, a silica-aluminate composite.

Typically, the oxide compound is pre-treated prior to incorporating the oxide compound into the reaction mixture by heating the oxide compound to a temperature of 300° C. or more. The oxide compound may be heated in air or in the presence of an inert atmosphere such as a nitrogen atmosphere. Typically, the oxide compound is pre-treated by calcination of the oxide compound. For example, silica may be calcined by heating to 600° C. for 10 hours in air or an inert atmosphere. The ramp rate for the calcination of silica may, for example, be 2° C./min.

Without wishing to be bound by theory, it is believed that heating the oxide compound changes the chemical bonds on the surface of the oxide compound, for example, by removing water absorbed on the surface of the oxide compound. This can result in a solid oxide with an increased proportion of strained chemical groups on the surface that are capable of forming radicals and thus initiating a radical polymerisation reaction.

The molar ratio of the oxide compound(s) to the one or more monomers may, for example, be in the range of about 1:100 to about 1:1000, typically in the range of about 1:100 to about 1:500, or about 1:500 to 1:1000.

The solvent may, for example, be supercritical carbon dioxide, supercritical methanol, subcritical carbon dioxide, subcritical methanol, hexane or methanol.

The method of the present invention may, for example, be used to polymerise one or more monomers selected from the group consisting of acrylates, alkenes, dienes and alkynes.

In some embodiments, the solid oxide compound is silica. Silica is a relatively cheap material, is non-toxic and environmentally friendly. Without wishing to be bound by theory, it is believed that strained chemical groups on the surface of the silica may, when exposed to a monomer and appropriate conditions, form reactive sites that are capable of initiating a radical polymerisation reaction. For example, possible reactive sites formed as a result of (a) homolytic or (b) heterolytic silicon-oxygen bond cleavage are depicted below.

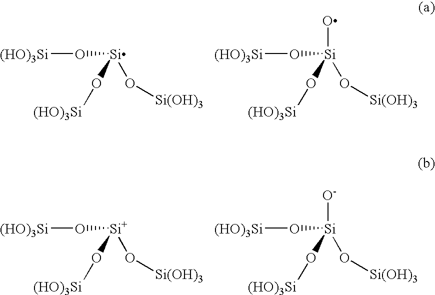

### Possible Reactive Sites Present on Sio₂ Following (a) Homolytic Bond Cleavage and (b) Heterolytic Bond Cleavage

In some embodiments, the oxide compound is mesoporous silica, which has a greater surface area than other forms of silica.

In some embodiments, the silica is pre-treated by calcination before being included in the reaction mixture.

The silica may, for example, be calcined by heating to 600° C. (ramp rate=2° C./min) for 10 hours in air.

The present invention further provides a method of forming a polymer, the method comprising the steps of:
(a) providing a reaction mixture that comprises:
   one or more monomers; and
   a solid oxide compound that contains less than 0.01 wt % of any other compound that is capable of initiating a radical polymerisation reaction; and
(b) polymerising the one or more monomers by a radical polymerisation reaction initiated by the oxide compound.

Typically, the one or monomers are dissolved in a solvent.

Step (b) may comprise exposing the reaction mixture to conditions (e.g. a temperature and pressure) whereby a radical polymerisation reaction is initiated by the oxide compound.

Typically, the reaction mixture consists essentially of one or more monomers dissolved in a solvent and one or more solid oxide compounds. As one skilled in the art will appreciate, if a solid oxide compound contains less than 0.01 wt % of any other compound that is capable of initiating a radical polymerisation reaction, then that other compound cannot cause any significant initiation of radical polymerisation reactions.

In another aspect, the present invention provides a polymer formed using the method of the present invention.

### DETAILED DESCRIPTION OF PREFERRED EMBODIMENTS OF THE INVENTION

### Solid Oxide Compound

As discussed above, the present invention relates generally to a method of forming a polymer, wherein the polymer is formed by a radical polymerisation reaction initiated by a solid oxide compound.

Any oxide compound which is solid under ambient conditions and capable of initiating a radical polymerisation reaction when exposed to appropriate conditions may be used.

The inventors believe that solid oxide compounds having covalent bonding are preferred for use in the methods of the present invention because the covalent bonds throughout the solid terminate at the surface of the solid and can form strained groups on the surface capable of forming radicals that can initiate a radical polymerisation reaction. Furthermore, such oxide compounds typically do not dissolve in solvents and therefore, when mixed with a solvent, can provide a heterogeneous material on which chemical groups capable of forming radicals that can initiate a radical polymerisation reaction are present on the surface.

The solid oxide compound is typically a metal oxide or metalloid oxide. Suitable solid oxide compounds include silica, titania, alumina, or composites of these oxides such as a silica-aluminate composite.

Typically the solid oxide is pre-treated by heating the solid oxide. Preferably, the solid oxide is subjected to calcination either in air or an inert atmosphere (e.g. a nitrogen atmosphere). In some embodiments, the solid oxide is pre-treated by heating the solid oxide to a temperature of at least 200° C. in air or an inert atmosphere. In some embodiments, the solid oxide is pre-treated by heating the solid oxide to a temperature of at least 300° C. in air or an inert atmosphere. In some embodiments, the solid oxide is pre-treated by heating the solid oxide to a temperature of at least 400° C. In some embodiments, the solid oxide is pre-treated by heating the solid oxide to a temperature of at least 450° C. In some embodiments, the solid oxide is pre-treated by heating the solid oxide to a temperature of at least 500° C. In some embodiments, the solid oxide is pre-treated by heating the solid oxide to a temperature of at least 600° C. Typically, the solid oxide is pre-treated by heating the solid oxide to a temperature of from 400° C. to 850° C. Typically the solid oxide is held at the pre-treatment temperature for a period of more than 5 hours, for example, for about 10 hours. Typically, the solid oxide is heated to the appropriate temperature at a specific rate, such as 2° C./min, 5° C./min or 10° C./min.

In some embodiments the oxide compound is silica. It is believed that strained chemical groups present on the surface of the silica are converted into radical groups when the silica is exposed to appropriate conditions, and that these radical groups are responsible for initiating polymerisation of the monomer. Two possible silica based radicals that are believed to be involved in this system are shown below.

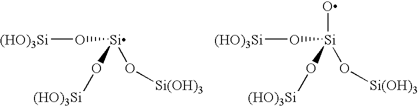

### Two Possible Radicals Formed on Silica as a Result of Homolytic Bond Cleavage

Once present, the radicals depicted above are able to initiate polymerisation of a monomer. The reaction schemes set out below show possible reaction pathways for the formation of poly(methyl acrylate). It is important to note that slightly different polymers will form, depending on which radical initiator starts the reaction.

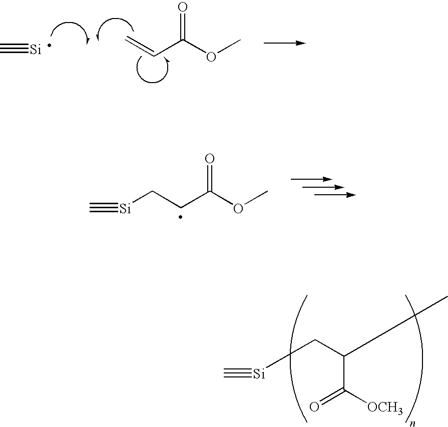

### Polymerisation of Methyl Acrylate with Si Based Radical

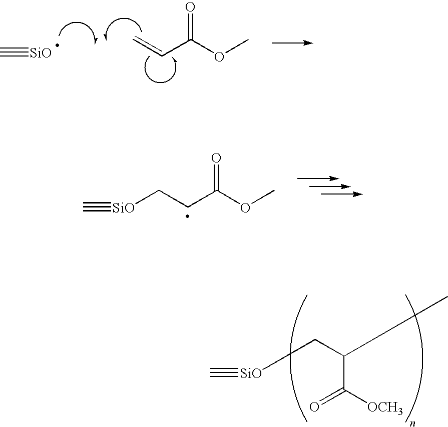

### Polymerisation of Methyl Acrylate with SiO Based Radical

Typical reaction conditions which cause formation of such radicals, and thus the initiation of the radical polymerisation reaction, vary depending on the nature of the reagents and solvent present. Typical reaction conditions vary between temperatures of between about 80° C. (e.g. if using refluxing hexane) and 360° C. (e.g. if using supercritical water) and pressures of between atmospheric pressure and 3600 psi. Appropriate reaction conditions can be determined by a person skilled in the art.

Strained chemical groups capable of forming radicals when exposed to appropriate conditions may be increased by pre-treating the silica, for example, by calcining the silica in an oven to a temperature of 600° C. for 10 hours (ramp rate=2° C./min). It is believed that these strained chemical groups are formed on the surface of the silica because water which has been absorbed by the silica is removed (by partial dehydroxylation of silanol groups).

Alternatively, strained chemical groups capable of forming radicals when exposed to appropriate conditions may be formed on the surface of the silica by heating the silica to a lower temperature (e.g. 200° C. or 300° C.).

Possible structures of strained chemical groups formed on the surface of silica using the above method, as well as the radicals that may be formed when exposed to appropriate conditions, are depicted below.

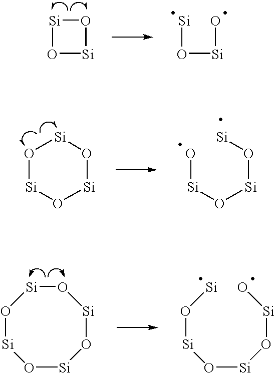

The inventors have found that strained chemical groups capable of forming radicals when exposed to appropriate conditions can remain on the surface of calcined silica for at least two months when stored at ambient conditions (i.e. in air at room temperature), and longer if it is stored under a nitrogen atmosphere. As such, no special storage or handling requirements are necessary.

The solid oxide compound(s) will typically be present in the reaction mixture in a molar ratio of between about 1:100 to about 1:1000 to the monomer(s) present in the reaction mixture. For example, the molar ratio of the oxide compound(s) to the one or more monomers may be in the range of about 1:100 to about 1:500, or about 1:500 to 1:1000.

In some embodiments, the solid oxide compound is in the form of particles of the solid oxide. Advantageously, providing a solid oxide compound in particulate form can provide a greater surface area of the solid oxide compound which may enhance the polymerisation reaction. Such particles may have a particle size of from about 1 nm to about 100 μm.

An increased surface area can also be achieved by using a mesoporous solid oxide, such as mesoporous silica.

In some embodiments, the solid oxide compound contains less than 0.01 wt % of any other compound that is capable of initiating a radical polymerisation reaction on the surface of the oxide compound or in the oxide compound.

In some embodiments, it may be possible to separate the solid oxide from the polymeric material produced for recycling in further reactions. However, in other embodiments, the solid oxide may be unrecoverable following the polymerisation reaction because it becomes incorporated into the polymer. Although this may mean that recycling of the solid oxide compound is not possible, as most solid oxides are relatively non-toxic and relatively easy to handle, it may not be necessary to remove the oxide via post polymerisation purification (unlike with many of the prior art polymerisation processes where toxic, expensive, and dangerous components are employed).

### Solvents

In some embodiments, a monomer could be used as a solvent (e.g. ethylene for the formation of polyethylene). Accordingly, in some embodiments, the reaction mixture does not comprise a solvent in addition to the one or more monomers. Typically, however, the reaction mixture comprises one or more monomers dissolved in a solvent. The solvent may be any solvent in which the one or more monomers are soluble.

Suitable solvents include supercritical carbon dioxide, supercritical methanol, subcritical carbon dioxide, subcritical methanol, hexane and methanol. As those skilled in the art will appreciate, solvent selection for a particular polymerisation reaction will depend on the nature of the reagents and the desired reaction conditions.

Recently, the use of supercritical solvents, such as supercritical carbon dioxide, in polymerisation reactions have been investigated in the hope of generating new and exciting materials.

The use of supercritical carbon dioxide, which is a relatively benign solvent, with a silica based heterogeneous initiator provides an environmentally friendly and sustainable technology.

In some embodiments, a mixture of two or more solvents is used. It is envisaged that by using a co-solvent, it would be possible to alter the conditions required to initiate the radical polymerisation reaction. In some embodiments, the co-solvent may be the monomer itself.

For example, when supercritical carbon dioxide is the solvent, the reaction occurs at an elevated temperature and pressure in order to achieve a supercritical state. It is envisaged that by using a co-solvent the same result could be obtained using lower temperatures, thereby reducing energy requirements and ultimately operating costs.

### Monomers

The method of the present invention is applicable to the production of a range of polymers that can be formed by radical polymerisation reactions. Possible systems include the production of various polymerised acrylates which have a wide range of applications such as the production of plastics, coatings, adhesives, paints as well as numerous electronic and biomedical devices. The method of the present invention has also demonstrated the ability to polymerise less reactive dienes, which may mean that polymerisation reactions that were not previously possible may become achievable in light of the present invention.

The method of the present invention can be used to polymerise both highly reactive monomers (e.g. methyl acrylate and/or styrene) and less reactive monomers (e.g. norbornadiene).

Classes of monomers which may be polymerised using the method of the present invention include acrylates, alkenes, dienes and alkynes.

Two or more monomers may be included in the reaction mixture in order to form a co-polymer. It is believed that the method of the present invention will be able to be modified in order to vary the nature of the polymer produced. For example, it is believed that the reaction conditions may be able to be modified in order to produce a particular co-polymer (e.g. a block or alternating co-polymer, etc).

### Steps (a) and (b)

The components of the reaction mixture may be combined in any order, using methods known in the art. If high temperatures and pressures are used in the method, then the reaction must be performed in apparatus capable of withstanding such conditions. In some embodiments, the monomer is dissolved in the solvent and then the solid oxide compound is added to the resultant solution. However, in other embodiments, for example when supercritical carbon dioxide is used as the solvent, the monomer is added to a reaction vessel along with the solid oxide compound, and then the vessel is charged with a precursor to the solvent, for example, carbon dioxide gas. Heating the reaction vessel to an elevated temperature causes the precursor to become the supercritical solvent into which the monomer dissolves.

The conditions required in order to perform step (b) will vary depending on the reagents in the reaction mixture. In embodiments in which the solid oxide is silica and the solvent is supercritical carbon dioxide, the radical polymerisation reaction is typically initiated by exposing the reaction mixture to a temperature of about 250° C. and a pressure of about 1100 psi. As will be appreciated, the temperatures referred to above may be decreased if the pressure is increased, and vice versa.

However, depending on the particular solvent, monomer and solid oxide used, one skilled in the art would appreciate that the radical polymerisation reaction may, for example, be initiated at temperatures of between about 70 and 360° C. and pressures of between atmospheric and about 3600 psi.

Once initiated, the reaction is maintained at a similar temperature and pressure for sufficient time to allow the monomer or monomers present in the reaction mixture to polymerise. This length of time will depend on the nature of the components of the reaction mixture and can be determined by one skilled in the art.

Advantageously, the method of the present invention can be carried out using non-toxic solvents, and relatively safe and inexpensive initiators, making the method easy to carry out and cost effective. In at least some embodiments, the solid oxide initiator is highly active at relatively low concentrations, thereby eliminating the need for post-production purification and recovery of the initiator.

### EXAMPLES

Preferred embodiments of the present invention will be described by way of example only, with reference to the following examples.

### Chemicals

Methyl acrylate (Merck), 2,5-norbornadiene (Lancaster), 2,6-di-tent-butyl phenol (Lancaster), industrial grade carbon dioxide (BOC), hexane (Merck) and silica (Ajax) were all used as received.

TUD-1, a mesoporous silica, was prepared as described by Jansen et al. (A new templaing method for three-dimensional mesopore networks, Jansen, J. C.; Shan, Z.; Marchese, L.; Zhou, W.; Puil, N. V. D.; Maschmeyer, T. Chem. Commun. 2001, 713-714).

MCM-41 was prepared as described by Beck et al. (A new family of mesoporous Molecular Sieves Prepared with Liquid Crystal Templates, Beck, J. S.; Vartuli, J. C.; Roth, W. J.; Leonowicz, M. E.; Kresge, C. T.; Schmitt, K. D.; Chu, C. T. W.; Olson, D. H.; Sheppard, E. W.; McCullen, S. B.; Higgins, J. B.; Schlenker, J. L. J. Am. Chem. Soc. 1992, 114, 10834-10843).

MCM-48 was prepared as described by Moller et al. (Entrapment of PMMA Polymer Strands in Micro- and Mesoporous Materials, Moller, K.; Bein, T.; Fischer, R. X. Chem. Mater. 1998, 10, 1841-1852).

TUD-1, MCM-41 and MCM-48 are types of mesoporous silica. The synthesis of each of these products involved the calcination of the product (i.e. calcination was part of the process described in the references referred to above).

The silica, TUD-1, MCM-41 and MCM-48 used in the Examples described below had a particle size of between 40 to 60 microns.

Reactions carried out at elevated temperatures and pressures were conducted in a 300 mL Parr high pressure reactor with gas inlet connection. Reactions requiring heating at reflux were carried out using readily available scientific glassware.

### Example 1

### Pre-Treatment of Silica

Silica was pre-treated by calcining at 600° C. (ramp rate=2° C./min) for 10 hrs in air to remove any physisorbed or chemisorbed water. The pre-treated silica was then stored in a desiccator to prevent any re-absorption of water.

### Example 2

### Preparation of Poly(Methyl Acrylate) in scCO₂

### Using Pre-Treated SiO₂

Pre-treated silica prepared in Example 1 (0.0975 g) and methyl acrylate (18 mL) were placed in the reactor, the vessel pressurised with carbon dioxide (460 psi) and the system allowed to equilibrate for 10 min. The system was re-pressurised with carbon dioxide (460 psi) and left to equilibrate for a further 10 min. The system was finally re-pressurised with carbon dioxide (460 psi) and heated in order to achieve sc carbon dioxide conditions. After 1 hr under sc-conditions the system was allowed to cool to room temperature and the carbon dioxide vented into the fumehood. Opening the reactor revealed poly(methyl acrylate) as a pale yellow, highly sticky polymer.

### Using TUD-1

TUD-1 (0.1892 g) and methyl acrylate (64 mL) were placed in the reactor, the vessel pressurised with carbon dioxide (460 psi) and the system allowed to equilibrate for 10 min. The system was re-pressurised with carbon dioxide (460 psi) and left to equilibrate for a further 10 min. The system was finally re-pressurised with carbon dioxide (460 psi) and heated in order to achieve sc carbon dioxide conditions. After 1 hr under sc-conditions the system was allowed to cool to room temperature and the carbon dioxide vented into the fumehood. Opening the reactor revealed poly(methyl acrylate) as a pale yellow, highly sticky polymer.

### Using MCM-41

MCM-41 (0.0420 g) and methyl acrylate (18 mL) were placed in the reactor, the vessel pressurised with carbon dioxide (460 psi) and the system allowed to equilibrate for 10 min. The system was re-pressurised with carbon dioxide (460 psi) and left to equilibrate for a further 10 min. The system was finally re-pressurised with carbon dioxide (460 psi) and heated in order to achieve sc carbon dioxide conditions. After 1 hr under sc-conditions the system was allowed to cool to room temperature and the carbon dioxide vented into the fumehood. Opening the reactor revealed poly(methyl acrylate) as a pale yellow, highly sticky polymer.

Using TUD-1 and 2,6-di-tert-butyl Phenol (a Common Radical Trap)

TUD-1 (0.0938 g), methyl acrylate (18 mL) and 2,6-di-tert-butyl phenol (0.3342 g) were placed in the reactor, the vessel pressurised with carbon dioxide (460 psi) and the system allowed to equilibrate for 10 min. The system was re-pressurised with carbon dioxide (460 psi) and left to equilibrate for a further 10 min. The system was finally re-pressurised with carbon dioxide (460 psi) and heated in order to achieve sc carbon dioxide conditions. After 1 hr under sc-conditions the system was allowed to cool to room temperature and the carbon dioxide vented into the fumehood. Upon opening the reactor there was a slight change in viscosity and colour, however there was no identifiable polymeric material that was present in the previous reactions.

This experiment indicates that the reaction mechanism involves the formation of radicals.

### Example 3

### Preparation of poly(norbornadiene) in scCO₂

Pre-treated silica prepared in Example 1 (0.1579 g) and 2,5-norbornadiene (60 mL) were placed in the reactor, the vessel pressurised with carbon dioxide (460 psi) and the system allowed to equilibrate for 10 min. The system was re-pressurised with carbon dioxide (460 psi) and left to equilibrate for a further 10 min. The system was finally re-pressurised with carbon dioxide (460 psi) and heated in order to achieve sc-carbon dioxide conditions. After 1 hr under sc-conditions the system was allowed to cool to room temperature and the carbon dioxide vented into the fumehood. Opening the reactor revealed poly(norbornadiene) as a pale orange, highly sticky material.

### Example 4

### Preparation of Poly(Methyl Acrylate) in Refluxing Hexane

### Using Pre-Treated SiO₂

Pre-treated silica prepared in Example 1 (0.0532 g), methyl acrylate (12 mL) and hexane (40 mL) were heated at reflux, while stirring, for 24 hr. The reaction mixture was allowed to cool to room temperature and the solvent decanted leaving a film like material that was washed with hexane to yield poly(methyl acrylate) as a pale yellow, highly sticky polymer.

### Using TUD-1

TUD-1 (0.0199 g), methyl acrylate (6 mL) and hexane (20 mL) were heated at reflux, while stirring, for 24 hr. The reaction mixture was allowed to cool to room temperature and the solvent decanted leaving a film like material that was washed with hexane to yield poly(methyl acrylate) as a pale yellow, highly sticky polymer.

### Example 5

### Preparation of Poly(Norbornene) in Refluxing Hexane

Pre-treated silica prepared in Example 1 (0.0489 g), 2,5-norbornadiene (12 mL) and hexane (40 mL) were heated at reflux, while stirring, for 24 hr. The reaction mixture was allowed to cool to room temperature and the solvent decanted leaving a film like material that was washed with hexane to yield poly(methyl acrylate) as a pale orange, highly sticky material.

### Example 6

### Preparation of poly(methylacrylate) in scCO₂

The method described in Example 2 under the heading “Using pre-treated SiO₂” was repeated. The same method was also carried out (1) omitting the pretreated silica, (2) using pre-treated silica but with a reaction time of 0.25 hour and (3) using pretreated silica that had been exposed to air at room temperature for three months prior to the reaction. For the reactions in which pretreated silica was used, the silica was pretreated as described in Example 1.

Gel permeation chromatopgraphy (GPC) was used to estimate the molecular weight distribution of the polymers produced. A Waters GPC was used. The samples of the resultant polymers were dissolved in THF and passed through four Waters Styragels columns (HR1, 2, 3, 4) connected in series at 313° K. using THF as the eluent with a flow rate of 1 mL/min. A refractive index detector was used and all samples were calibrated against polystyrene standards with molecular weights ranging from 162-54 000 amu.

The results are shown in Table 1. In Table 1M_{w} represents the average molecular weight for the sample, Mₙ is the number average of molecules displaying the average molecular weight, and the PDI is the polydispersity index (PDI=M_{w}/Mₙ).

TABLE 1
GPC data for polymerisation of MA in scCO₂ using different
silica based initiators.

| Initiator | Time (h) | Mₙ | M_{w} | PDI |
|---|---|---|---|---|
| None | 1 | 798 | 4 117 | 5.16 |
| Calcined SiO₂ | 0.25 | 2 668 | 15 257 | 5.72 |
| Calcined SiO₂ | 1 | 12 230 | 15 324 | 1.25 |
| Calcined SiO₂* | 1 | 1 741 | 10 114 | 5.81 |

*Denotes SiO₂ that was calcined and then exposed to air at room temperature for 3 months prior to use.

The results shown in Table 1 demonstrate that when methylacrylate alone is dissolved in supercritical CO₂ for one hour, only very small molecular weight products are obtained giving rise to a very broad PDI of 5.16. When freshly calcined silica is used, larger molecular weights are achievable after only 15 minutes. By extending the reaction time to one hour it is possible to produce PMA that displays a narrow PDI of 1.25. The reaction carried out using silica that had been calcined and then exposed to air at room temperature for three months prior to use resulted in lower molecular weight PMA with a broader PDI indicative of a range of molecular weights. These results indicate that when freshly calcined silica is exposed to the atmosphere for three months prior to use, some loss in polymerisation activity and selectivity is observed.

### Example 7

### Preparation of poly(methylacrylate) in scCO₂

The method described in Example 2 under the heading “Using pretreated SiO₂” was carried out using pretreated silica heated to 300° C., 600° C. and 850° C. For each pretreatment process, the silica was heated to the pretreatment temperature for 10 hours (ramp rate=2° C./min). The silica was held at the pretreatment temperature for 10 hours under constant air flow.

The yield of poly(methylacrylate) is shown in Table 2.

The results show that for all the pretreatment temperatures tested, the silica was capable of initiating the polymerization of methylacrylate. The highest yield was obtained using the calcination temperature of 600° C.

TABLE 2

| Pretreatment Temp (° C.) | Poly(methylacrylate) yield (%) |
|---|---|
| 300 | 63 |
| 600 | 85 |
| 850 | 59 |

A reference herein to a prior art document is not an admission that the document forms part of the common general knowledge in the art in Australia.

In the claims which follow and in the preceding description, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments.

1. A method of forming a polymer, wherein the polymer is formed by a radical polymerisation reaction initiated by a solid oxide compound.

2. A method of forming a polymer, comprising the steps of:
a) providing a reaction mixture that comprises:
one or more monomers; and
a solid oxide compound; and
b) polymerising the one or monomers by a radical polymerisation reaction initiated by the oxide compound.

3. The method of claim 2, wherein the one or more monomers in the reaction mixture are dissolved in a solvent.

4. The method of claim 2, wherein the reaction mixture consists essentially of one or more monomers dissolved in a solvent and one or more solid oxide compounds.

5. The method of claim 3, wherein the solvent is supercritical carbon dioxide, supercritical methanol, subcritical carbon dioxide, subcritical methanol, hexane or methanol.

6. The method of claim 2, wherein step (b) comprises exposing the reaction mixture to conditions whereby a radical polymerisation reaction is initiated by the oxide compound.

7. The method of claim 2, wherein the molar ratio of the oxide compound(s) to the one or more monomers is in the range of about 1:100 to about 1:1000.

8. The method of claim 2, wherein the one or more monomers are selected from the group consisting of acrylates, alkenes, dienes and alkynes.

9. The method of claim 1, wherein the oxide compound is silica, titania or alumina.

10. The method of claim 1, wherein the oxide compound is a composite of two or more of silica, titania or alumina.

11. The method of claim 1, wherein the oxide compound has been pre-treated by heating the oxide compound to a temperature of at least 300° C.

12. The method of claim 11, wherein the oxide compound is heated in air.

13. The method of claim 1, wherein the oxide compound is silica.

14. The method of claim 1, wherein the oxide compound is mesoporous silica.

15. The method of claim 13, wherein the silica is pre-treated by calcination in air.

16. The method of claim 15, wherein one or monomers are dissolved in supercritical carbon dioxide and the radical polymerisation reaction is initiated by radicals formed on the surface of the silica.

17. The method of claim 16, wherein the radical polymerisation reaction is initiated by exposing the reaction mixture to a temperature of about 250° C. and to a pressure of about 1100 psi.

18. A method of forming a polymer, comprising the steps of:
a) providing a reaction mixture that comprises:
one or more monomers; and
a solid oxide compound that contains less than 0.01 wt % of another compound that is capable of initiating a radical polymerisation reaction; and
b) polymerising the one or monomers by a radical polymerisation reaction initiated by the oxide compound.

19. The method of claim 18, wherein the one or more monomers in the reaction mixture are dissolved in a solvent.

20. The method of claim 18, wherein the reaction mixture consists essentially of one or more monomers dissolved in a solvent and one or more solid oxide compounds.

21. The method of claim 18, wherein step (b) comprises exposing the reaction mixture to conditions whereby a radical polymerisation reaction is initiated.

22. A polymer formed using the method of claim 1.
